(19) United States
(12) Patent Application Publication
(10) Pub. No.: US 2025/0238155 A1
(43) Pub. Date: Jul. 24, 2025

(54) IO PROCESSING METHOD AND APPARATUS, DEVICE, AND STORAGE MEDIUM

(71) Applicant: IEIT SYSTEMS Co., Ltd., Jinan (CN)

(72) Inventors: Hui LI, Jinan (CN); Hongyu Zhu, Jinan (CN); Jian Wang, Jinan (CN); Dan Liu, Jinan (CN); Shansong Yang, Jinan (CN); Kun He, Jinan (CN)

(73) Assignee: IEIT SYSTEMS Co., Ltd., Jinan (CN)

(21) Appl. No.: 19/176,644

(22) Filed: Apr. 11, 2025

Related U.S. Application Data
(63) Continuation of application No. PCT/CN2024/074819, filed on Jan. 31, 2024.

(30) Foreign Application Priority Data
Feb. 16, 2023 (CN) 202310121093.2

(51) Int. Cl. G06F 3/06

(52) U.S. Cl. CPC G06F 3/0644; G06F 3/0619; G06F 3/0659; G06F 3/0689

(57) ABSTRACT

An IO processing method and apparatus, a device, and a storage medium are disclosed. The method includes: acquiring IO data sent by a user by means of a logical volume, and sending, by using the logical volume, the IO data to a data cache by a first controller; allocating a second controller to the IO data by a RAID, and synchronizing the IO data from the first controller to the second controller by the data cache; and determining a target address space according to a pre-partitioned RAID layer address space by the second controller if the IO data is a data write request, and performing a data write operation on the target address space based on the IO data, where the pre-partitioned RAID layer address space is a RAID layer address space generated after partitioning a corresponding address space for each controller at a RAID layer.

### CROSS-REFERENCE TO RELATED APPLICATION

This application is a continuation of PCT International Patent Application No. PCT/CN2024/074819, filed Jan. 31, 2024, which claims priority to Chinese Patent Application No. 202310121093.2, filed on Feb. 16, 2023 in China National Intellectual Property Administration and entitled “IO Processing Method and Apparatus, Device, and Storage Medium”. The contents of PCT International Patent Application No. PCT/CN2024/074819 and Chinese Patent Application No. 202310121093.2 are each hereby incorporated by reference in their entireties.

### FIELD

The present application relates to the field of computer technologies, and in particular to an IO processing method and apparatus, a device, and a storage medium.

### BACKGROUND

A redundant array of independent disks (RAID) is a disk system composed of a plurality of independent disks, which may achieve better storage performance and higher reliability than a single disk. A multi-controller system refers to use of a plurality of controllers to jointly process read and write operations of users, achieving a performance overlay and a security overlay of the plurality of controllers.

When the plurality of controllers accesses a same address space, resource access conflicts may arise. Address space partitioning at a logical volume layer ensures independent controller access to the address space. The address space is isolated by space to prevent interdomain information crossing and avoids resource access conflicts.

However, the address space partitioning provided by the logical volume requires address mapping transformation, that is, the RAID needs to follow address partitioning rules provided by the logical volume. During operation, the RAID needs to query domains corresponding to the address space in real time, and the read and write operations initiated autonomously by the RAID need to read the address space partitioning provided by the logical volume, that is, when processing IO (Input or Output) requests, the RAID remains dependent on the logical volume and may not operate independently. Moreover, when spatial affiliation partitioning of the logical volume changes, a RAID layer needs to change an address affiliation accordingly, which may lead to frequent stripe changes, and reduce flexibility and efficiency of IO processing.

### SUMMARY

In one or more aspects, the present application discloses an input or output (IO) processing method, including:
acquiring IO data sent by a user by means of a logical volume, and sending, by using the logical volume, the IO data to a data cache by means of a first controller;
allocating a second controller to the IO data by means of a redundant array of independent disks (RAID), and synchronizing the IO data from the first controller to the second controller by means of the data cache; and
determining a target address space according to a pre-partitioned RAID layer address space by means of the second controller in response to a determination that the IO data is a data write request, and performing a data write operation on the target address space based on the IO data, where the pre-partitioned RAID layer address space is a RAID layer address space generated after partitioning a corresponding address space for each controller at a RAID layer.

In one or more embodiments, the partitioning a corresponding address space for each controller at a RAID layer includes:
performing address space partitioning at the RAID layer in a unit of stripe according to an address partitioning rule, and assigning a unique controller to each group of address spaces.

In one or more embodiments, the IO processing method further includes:
partitioning, by means of the logical volume, a target unit-length space as a data block from an address space corresponding to a controller according to the RAID layer address space, so as to obtain a plurality of data blocks corresponding to a plurality of controllers, where the plurality of data blocks are configured to receive the IO data written by a user into the logical volume.

In one or more embodiments, the allocating a corresponding second controller to the IO data by means of a RAID includes:
selecting, by the RAID, a target storage address space from address spaces according to a current load condition of each address space; and
taking the controller corresponding to the target storage address space as the second controller by querying the RAID layer address space.

In one or more embodiments, after the allocating a corresponding second controller to the IO data by means of a RAID, the method further includes:
judging whether the second controller and the first controller are the same controller in response to a determination that the IO data is a data write request; and
in response to a judgment that the second controller and the first controller are the same controller, re-selecting a controller except the first controller as the second controller.

In one or more embodiments, the re-selecting a controller except the first controller as the second controller includes:
selecting a next controller of the first controller as the second controller according to preset controller cyclic data.

In one or more embodiments, the re-selecting a controller except the first controller as the second controller includes:
randomly selecting a controller, other than the first controller, from controllers as the second controller.

In one or more embodiments, after the synchronizing the IO data from the first controller to the second controller by means of the data cache, the method further includes:
generating a data write completion result, and sending a data backup completion result to the logical volume.

In one or more embodiments, the synchronizing the IO data from the first controller to the second controller includes:
backing up the IO data stored in a cache region corresponding to the first controller to a cache region corresponding to the second controller.

In one or more embodiments, after the synchronizing the IO data from the first controller to the second controller by means of the data cache, the method further includes:
generating synchronization node pair information corresponding to the IO data based on controller information of the first controller and the second controller, and storing the synchronization node pair information.

In one or more embodiments, after the storing the synchronization node pair information, method further includes:
notifying a corresponding controller to discard the old cached data based on the synchronization node pair information when a cache is updated, and establishing new synchronization node pair information.

In one or more embodiments, the performing a data write operation on the target address space based on the IO data includes:
judging whether any controller is reading data in the target address space; and
in response to no controller reading data in the target address space, performing data flushing to the target address space based on the IO data.

In one or more embodiments, after the judging whether any controller is reading data in the target address space, the method further includes:
in response to a controller reading data in the target address space, detecting an accessed state of the target address space; and
performing data flushing to the target address space based on the IO data in response to no controller reading data in the target address space.

In one or more embodiments, after the synchronizing the IO data from the first controller to the second controller by means of the data cache, the method further includes:
judging whether the second controller and the first controller are a same controller in response to a determination that the IO data is a data read request;
in response to a judgment that the second controller and the first controller are the same controller, judging, by means of the first controller, whether target data corresponding to the IO data exists in the cache region corresponding to the first controller; and
in response to the target data existing in the cache region corresponding to the first controller, directly reading the target data, and feeding back the target data to the logical volume.

In one or more embodiments, after the judging whether target data corresponding to the IO data exists in a cache region corresponding to the first controller, the method further includes:
in response to no target data existing in the cache region corresponding to the first controller, reading, by means of the first controller, the target data corresponding to the IO data from the RAID, and feeding back the target data to the logical volume.

In one or more embodiments, after the judging whether the second controller and the first controller are a same controller, the method further includes:
in response to a judgment that the second controller and the first controller are not the same controller, judging, by means of the second controller, whether target data corresponding to the IO data exists in a cache region corresponding to the second controller; and
in response to the target data existing in the cache region corresponding to the second controller, directly reading the target data, and feeding back the target data to the first controller, so as to allow the first controller to forward the target data to the logical volume.

In one or more embodiments, after judging whether target data corresponding to the IO data exists in a cache region corresponding to the second controller, the method further includes:
in response to no target data existing in the cache region corresponding to the second controller, sending data read failure information to the first controller, to allow the first controller to read the target data corresponding to the IO data from the RAID after receiving the data read failure information and feed back the target data to the logical volume.

In one or more aspects, the present application discloses an IO processing apparatus, including:
a data sending module, configured to acquire IO data sent by a user by means of a logical volume, and send, by using the logical volume, the IO data to a data cache by means of a first controller;
a data synchronization module, configured to allocate a corresponding second controller to the IO data by means of a redundant array of independent disks (RAID), and synchronize the IO data from the first controller to the second controller by means of the data cache; and
a data write module, configured to determine a corresponding target address space according to a pre-partitioned RAID layer address space by means of the second controller in response to a determination that the IO data is a data write request, and perform a data write operation on the target address space based on the IO data, where the pre-partitioned RAID layer address space is a RAID layer address space generated after partitioning the corresponding address space for each controller at a RAID layer.

In one or more aspects, the present application discloses an electronic device, including a memory and one or more processors, where the memory has a computer-readable instruction stored therein, and the computer-readable instruction, when executed by the one or more processors, causes the one or more processors to perform steps of the foregoing method.

In one or more aspects, the present application discloses a non-transitory computer-readable storage medium, which is configured to store a computer-readable instruction, where the computer-readable instruction, when executed by one or more processors, causes the one or more processors to perform steps of the foregoing method.

### BRIEF DESCRIPTION OF THE DRAWINGS

In order to describe the embodiments of the present application or the technical solutions in the related art more clearly, drawings required to be used in the embodiments or the illustration of the related art will be briefly introduced below. Apparently, the drawings described below are only some embodiments of the present application. Those ordinarily skilled in the art may also obtain other drawings according to the provided drawings without contributing creative work.

FIG. 1 is a flowchart of an IO processing method provided by some embodiments of the present application;

FIG. 2 is a flowchart of another IO processing method provided by some embodiments of the present application;

FIG. 3 is a flowchart of another IO processing method provided by some embodiments of the present application;

FIG. 4 is a schematic structural diagram of an IO processing apparatus provided by some embodiments of the present application;

FIG. 5 is a structural diagram of an electronic device provided by some embodiments of the present application; and

FIG. 6 is a schematic structural diagram of a non-transitory computer-readable storage medium provided by some embodiments of the present application;

FIG. 7 is a schematic structural diagram of an IO processing system provided by some embodiments of the present application.

### DETAILED DESCRIPTION

To make the purposes, technical solutions, and advantages of embodiments of the present application clearer, the technical solutions in embodiments of the present application are described clearly and completely in conjunction with accompanying drawings in the embodiments of the present application. Apparently, the described embodiments are some embodiments of the present application, not all embodiments. Based on the embodiments of the present application, other embodiments obtained by a person of ordinary skill in the art without creative efforts shall fall within the protection scope of the present application.

In the related art, address space partitioning is performed at a logical volume layer. However, the address space partitioning provided by a logical volume requires address mapping transformation, that is, a redundant array of independent disks (RAID) remains dependent on the logical volume when processing IO (Input or Output) requests and may not operate independently. Moreover, when spatial affiliation partitioning of the logical volume changes, a RAID layer needs to change an address affiliation accordingly, which may lead to frequent stripe change. A strip is that a plurality of blocks is combined into a stripe by means of an array, and one stripe crosses a plurality of disks. A block is that a disk space is partitioned into blocks by means of the array. IO processing flexibility and efficiency may be reduced. To solve above problems, the present application provides an IO processing method, which may reduce the performance degradation caused by the affiliation change, isolate the balance conduction of data across the logical volumes, and improve the system performance.

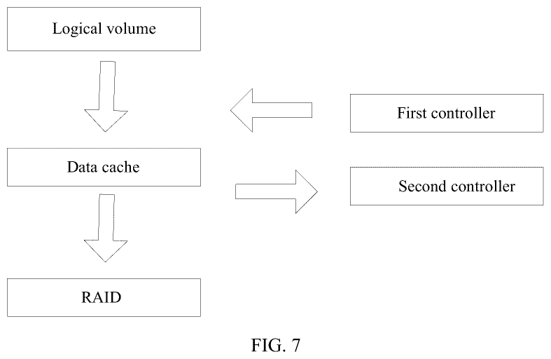

For the convenience of understanding, first describe a system applicable to the present application. The IO processing method provided in the application can be applied to a system architecture shown in FIG. 7. The system includes a logical volume, a data cache, a RAID, a first controller and a second controller. The logical volume divides space of RAID into different zones for more convenient unified management and allocation. The Data cache refers to temporarily storing data in memory for quick access and reading of data. In addition, the data cache is also configured for data mirroring between controllers. Controllers refer to multiple physical machines capable of running the system used in the present application, with at least two controllers used for mutual backup of data. RAID uses multiple independent disks to form a large disk system, achieving better storage performance and higher reliability than a single disk.

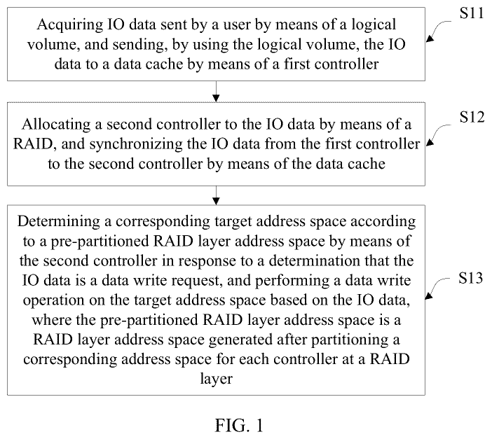

Some embodiments of the present application disclose an IO processing method. Referring to FIG. 1, the method may include the following steps:

Step S11: acquiring IO data sent by a user by means of a logical volume, and sending, by using the logical volume, the IO data to a data cache by means of a first controller.

In the present embodiment, the IO data sent by the user is acquired by means of the logical volume, and the IO data is sent by using the logical volume to the data cache by means of the first controller. The first controller is directly interfaced with the user, and the first controller is configured to send the IO data to the data cache, but it is not responsible for data flushing.

In the present embodiment, a step of partitioning a corresponding address space for each controller at a RAID layer may include: performing address space partitioning at the RAID layer in a unit of stripe according to an address space partitioning rule, and assigning a unique controller to each group of address spaces. That is, the RAID layer autonomously determines the address space partitioning. Read/write operations generated by the RAID layer after partitioning, including but not limited to initialization, reconfiguration, and the like, do not need to be scheduled according to the address space partitioning rule of the logical volume. An address space partitioning strategy may be as follows: a group of aligned stripes is allocated to a controller A, while a second group is allocated to a controller B, and the allocation is cyclically performed until all address spaces is allocated. In a mathematical form, for an array with the number of controllers being n and the number of drivers being c, a stripe numbered s is allocated to the controller (s/c) on (i.e. a remainder of (s/c)/n). According to the aforementioned address space partitioning rule, a single controller accesses a single address space. That is, one address space supports the corresponding controller for data flushing, and there is no multiple controllers performing data flushing to the same address space. The spatial isolation obviates the requirement for controller unlocking.

In the present embodiment, the IO processing method may further include: partitioning, by means of the logical volume, a target unit-length space as a data block from an address space corresponding to a controller according to the RAID layer address space, so as to obtain a plurality of data blocks corresponding to a plurality of controllers, where the plurality of data blocks are configured to receive the IO data written by a user into the logical volume. That is, the logical address space provided by the RAID is partitioned by the logical volume into blocks of a specified length unit, a group of blocks is partitioned to be provided for the user to use according to the user requirement, and the blocks of the logical volume are evenly selected from a plurality of controllers to ensure performance balance among the controllers. When the user writes the data into the logical volume, the logical volume transfers the data to the data cache, and when the user reads the data, the logical volume call the data cache for obtaining the data. Compared with a method in the related art where the full-stack address affiliation is the same, the present embodiment decouples the address affiliation partitioning of the logical volume layer from that of the RAID layer, whereby the logical volume layer and the RAID layer have distinct address affiliation partitions.

Step S12: allocating a second controller to the IO data by means of a RAID, and synchronizing the IO data from the first controller to the second controller by means of the data cache.

In the present embodiment, after the IO data enters the data cache, the corresponding second controller is allocated by the RAID to the IO data. The second controller is configured to actually perform the data flushing of the IO data from the data cache to the disk. The IO data is synchronized from the first controller to the second controller by means of the data cache, that is, the IO data is backed up to the second controller. In the present embodiment, the synchronizing the IO data from the first controller to the second controller may include: backing up the IO data stored in a cache region corresponding to the first controller to a cache region corresponding to the second controller. That is, the data cache provides a function of synchronizing data among different controllers. The data stored in the data cache is at least backed up to another controller to ensure that the data may not be lost when the controller is offline. The data cache of the system performs data backup according to an address space partitioning strategy provided by a RAID module. It may be seen that by using the data cache, an existing operation, the data synchronization among the controller may be implemented without needing the controller to forward the data separately, thereby significantly reducing the data read delay, and improving the system performance.

In the present embodiment, the allocating a corresponding second controller to the IO data by means of a RAID may include: selecting, by the RAID, a target storage address space from address spaces according to a current load condition of each address space; and taking the controller corresponding to the target storage address space as the second controller by querying the RAID layer address space. That is, the RAID layer autonomously determines the controller for actually performing the data flushing and the address space to which the data is written, thereby achieving load balancing of the RAID.

Step S13: determining a corresponding target address space according to a pre-partitioned RAID layer address space by means of the second controller in response to a determination that the IO data is a data write request, and performing a data write operation on the target address space based on the IO data, where the pre-partitioned RAID layer address space is a RAID layer address space generated after partitioning a corresponding address space for each controller at a RAID layer.

In the present embodiment, the IO data is determined to be the data write request. Upon determining that the IO data is the data write request, a unique address space is determined as the target address space according to the pre-partitioned RAID layer address space by means the second controller, and the data write operation is performed on the target address space based on the IO data, where the pre-partitioned RAID layer address space is the RAID layer address space generated after partitioning the corresponding address space for each controller at the RAID layer. That is, the RAID layer autonomously determines the controller for actually performing the data flushing and the address space to which the data is written. At this time, from the perspective of the logical volume layer, the first controller performs the IO processing, but actually the data flushing is performed by the second controller. Therefore, multiple controllers are allowed to write data to a same RAID region from the perspective of the logical volume layer, and there is no controller lock or read-write lock in the RAID.

In the present embodiment, after the allocating a corresponding second controller to the IO data by means of a RAID, the method may further include: judging whether the second controller and the first controller are the same controller in response to a determination that the IO data is the data write request; and in response to a judgment that the second controller and the first controller are the same controller, re-selecting a controller except the first controller as the second controller. That is, to ensure that data exists on at least two controllers, i.e. achieving data backup, it is necessary to ensure that the second controller and the first controller are not the same controller. In this embodiment, the first controller is determined by the logical volume layer, while the second controller is determined by the RAID layer. Since there is no association between the two, it is essential to perform the aforementioned judgment after the second controller is determined.

In the present embodiment, re-selecting a controller except the first controller as the second controller may include: selecting a next controller of the first controller as the second controller according to preset controller cyclic data. In the present embodiment, the re-selecting a controller except the first controller as the second controller may include: randomly selecting a controller, other than the first controller, from controllers as the second controller. That is, one controller may be selected randomly, or the next controller may be selected according to a predetermined cyclic mirroring rule.

For example, after receiving the data write request, the data cache determines whether the logical volume issues a write operation from a controller A to the data cache. Based on the determination that the logical volume issues the write operation from the controller A to the data cache, and that a region allocated for the write operation in the RAID module address space is also assigned to the controller A, the data cache synchronizes the data from the controller A to a controller A+1. Upon the completion of data backup, write success information is returned to the logical volume. For another example, after the data cache receives the data write request, the logical volume issues the write operation from the controller A to the data cache, while the region allocated for the write operation in the RAID module address space is assigned to a controller B, whereby the data cache backs up the data to the controller B from the controller A. Upon the completion of data backup, write success information is returned to the logical volume.

In the present embodiment, after the synchronizing the IO data from the first controller to the second controller by means of the data cache, the method may further include: generating a data write completion result, and sending a data backup completion result to the logical volume. That is, in the present embodiment, after the data is backed up to the second controller, it may be considered that the data backup is completed without waiting until the data is actually written to the disk.

In the present embodiment, after the synchronizing the IO data from the first controller to the second controller by means of the data cache, the method may further include: generating synchronization node pair information corresponding to the IO data based on controller information of the first controller and the second controller, and storing the synchronization node pair information. In the present embodiment, after the storing the synchronization node pair information, the method may further include: determining whether the cache is updated, and notifying a corresponding controller to discard the old cached data according to the synchronization node pair information based on the determination that the cache is updated, and establishing new synchronization node pair information. Taking the case as an example in which the logical volume issues the write operation from the controller A to the data cache, while the region allocated for the write operation in the RAID module address space is assigned to the controller B, in the region that is allocated to the controller B by means of the RAID module, the write operation data may be certainly synchronized or directly sent to the controller B, and the data cache needs to record the synchronous node of the currently cached data, i.e. the controller A and the controller B. Upon determining that the data in the cache is updated, the current synchronization node is notified to discard the old cached data, and a new synchronization relationship is established.

In the present embodiment, the performing a data write operation on the target address space based on the IO data may include: judging whether any controller is reading data in the target address space; and in response to no controller reading data in the target address space, performing data flushing to the target address space based on the IO data. In the present embodiment, after the judging whether any controller is reading data in the target address space, the method may further include: in response to a controller reading data in the target address space, detecting an accessed state of the target address space; and performing data flushing to the target address space based on the IO data in response to no controller reading data in the target address space.

It may be understood that the data cache continuously flushes the data to the RAID, and when detecting that the data in the cache is assigned to the current controller according to the RAID address affiliation, and no controller is currently reading the data, the data cache of each controller may perform the data flushing to the region; and otherwise, the data flushing may not be performed, or the data flushing may be performed later. Consequently, the data cache provides a function of isolating the address affiliation partitioning between the logical volume layer and the RAID layer by temporarily storing the data, thereby controlling the mutual exclusion of read and write operations across multiple controllers.

As may be seen from the above, in some embodiments, in the present embodiment, the IO data sent by the user is acquired by means of the logical volume, and the IO data is sent, by using the logical volume, to the data cache by means of the first controller; the corresponding second controller is allocated to the IO data by means of the RAID, and the IO data is synchronized from the first controller to the second controller by means of the data cache; and whether the IO data is the data write request is determined, upon determining the IO data is the data write request, the corresponding target address space is determined according to the pre-partitioned RAID layer address space by means of the second controller, and the data write operation is performed on the target address space based on the IO data, where the pre-partitioned RAID layer address space is a RAID layer address space generated after partitioning a corresponding address space for each controller at the RAID layer. It may be seen that by independently partitioning the address space at the RAID layer and utilizing the data cache to isolate the address attribution partitioning between the logical volume layer and the RAID layer, thereby separating the address attribution partitioning of the logical volume layer and that of the RAID layer. After the logical volume sends the data to the data cache, the RAID re-determines the controller, and flushes the data in the data cache to the RAID layer according to its own address space. That is, the address attribution partitioning of the RAID does not relay on that of the logical volume, that is, when the address attribution partitioning of the RAID changes, the RAID layer does not need to change the address attribution partitioning accordingly, thereby improving the flexibility of the RAID layer, alleviating the performance degradation caused by the attribution change, isolating the balance conduction of data across the logical volumes, and improving the system performance.

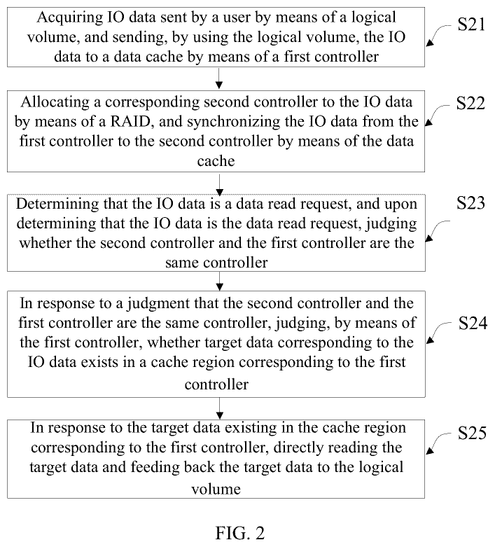

Some embodiments of the present application disclose an IO processing method. Referring to FIG. 2, the method may include the following steps:

Step S21: acquiring IO data sent by a user by means of a logical volume, and sending, by using the logical volume, the IO data to a data cache by means of a first controller.

Step S22: allocating a corresponding second controller to the IO data by means of a RAID, and synchronizing the IO data from the first controller to the second controller by means of the data cache.

Step S23: determining that the IO data is a data read request, and upon determining that the IO data is the data read request, judging whether the second controller and the first controller are the same controller.

Step S24: in response to a judgment that the second controller and the first controller are the same controller, judging, by means of the first controller, whether target data corresponding to the IO data exists in a cache region corresponding to the first controller.

Step S25: in response to the target data existing in the cache region corresponding to the first controller, directly reading the target data, and feeding back the target data to the logical volume.

In the present embodiment, after the judging whether target data corresponding to the IO data exists in a cache region corresponding to the first controller, the method may further include: in response to no target data existing in the cache region corresponding to the first controller, reading the target data corresponding to the IO data from the RAID by means of the first controller, and feeding back the target data to the logical volume.

In some embodiments, in the present embodiment, the target data is first read from the cache region, and in response to no target data existing in the cache region, the target data is read from the RAID. A difference between a data read operation and a data write operation is that during data write operation, the controller needs to store the data into a certain address space corresponding to the controller according to the pre-partitioned RAID layer address space, but during the data read operation, the data may be read from disks of the RAID. For example, when the data cache receives a data read request from the controller A, in response to a determination that the RAID allocates the address space to the controller A, the data may be directly read from the data cache of the controller A. Whether the target data exists in the data cache is determined, and upon determining the presence of the target data in the data cache, the target data is returned directly; and otherwise, the target data is read from the RAID layer and stored into a read cache.

It may be seen that the data read and write operations in the present embodiment involves three main levels, i.e. the logical volume, the data cache, and the disk array. The data cache backs up the data according to the address space affiliation of the RAID, when the data is flushed to the RAID, the data is flushed according to the address partitioning of the RAID layer, whereby the independent address space of the RAID may only write the data from one controller in a multi-controller system; and during the data read operation, the data backup is not performed, and the data may be read from a plurality of controllers.

For the process of the aforementioned step S21 and step S22, refer to related content disclosed in the aforementioned embodiments. Details are not described again herein.

As may be seen from the above, in the present embodiment, in response to a determination that the IO data is the data read request, whether the second controller and the first controller are the same controller is judged; in response to a judgment that the second controller and the first controller are the same controller, whether the target data corresponding to the IO data exists in the cache region corresponding to the first controller is judged by means of the first controller; and in response to a judgment that the target data exists in the cache region corresponding to the first controller, the target data is read directly, and fed back to the logical volume. A plurality of controllers are allowed to read the data from the same region of the RAID.

Some embodiments of the present application disclose an IO processing method. Referring to FIG. 3, the method may include the following steps:

Step S31: acquiring IO data sent by a user by means of a logical volume, and sending, by using the logical volume, the IO data to a data cache by means of a first controller.

Step S32: allocating a corresponding second controller to the IO data by means of a RAID, and synchronizing the IO data from the first controller to the second controller by means of the data cache.

Step S33: determining that the IO data is a data read request, and upon determining that the IO data is the data read request, judging whether the second controller and the first controller are the same controller.

Step S34: in response to a judgment that the second controller and the first controller are not the same controller, judging, by means of the second controller, whether target data corresponding to the IO data exists in a cache region corresponding to the second controller.

Step S35: in response to the target data existing in the cache region corresponding to the second controller, directly reading the target data, and feeding back the target data to the first controller, so as to allow the first controller to forward the target data to the logical volume.

In the present embodiment, after the judging whether target data corresponding to the IO data exists in a cache region corresponding to the second controller, the method may further include: in response to no target data existing in the cache region corresponding to the second controller, sending data read failure information to the first controller, so as to allow the first controller to read the target data corresponding to the IO data from the RAID after receiving the data read failure information, and feed back the target data to the logical volume.

For example, when the data cache receives the read request from controller A, in response to a determination that the address space of the RAID module is allocated to controller B, the data cache of controller B is read. In response to a determination that the target data exists in the cache of the controller B, the data is copied directly from the controller B to the controller A, and returned to the logical volume for user access. The data copy process is also implemented by means of the data cache. During the data read operation, the sequence of data read and write operations in the RAID may be controlled by means of an update logic of the data cache. In response to a determination that the target data is cached in the controller B, the controller B records that controller A is reading the data, and returns a message of no data caching to the controller A. Then the controller A retrieves the data from the RAID layer, and returns the data to the logical volume for user access. Finally, the controller A notifies controller B of the completion of data read operation.

For the process of the aforementioned step S31, step S32, and step S33, refer to related content disclosed in the aforementioned embodiments. Details are not described again herein.

As may be seen from the above, in the present embodiment, in response to a determination that the IO data is the data read request, whether the second controller and the first controller are the same controller is judged; in response to a judgment that the second controller and the first controller are not the same controller, whether the target data corresponding to the IO data exists in the cache region corresponding to the second controller is judged by means of the second controller; and in response to a judgment that the target data exists in the cache region corresponding to the second controller, the target data is read directly, and fed back to the first controller, so as to allow the first controller to forward the target data to the logical volume. Thus, it may be seen that a plurality of controllers are allowed to read the data from the same region of RAID.

The logical volume sends the IO data to the data cache by means of the first controller; the corresponding second controller is allocated to the IO data by means of the RAID, and the IO data is synchronized from the first controller to the second controller by means of the data cache; and in response to a determination that the IO data is the data write request, the corresponding target address space is determined according to a pre-partitioned RAID layer address space by means of the second controller, and the data write operation is performed on the target address space based on the IO data, where the pre-partitioned RAID layer address space is a RAID layer address space generated after partitioning a corresponding address space for each controller at the RAID layer. It may be seen that by independently partitioning the address space at the RAID layer and utilizing the data cache to isolate the address attribution partitioning between the logical volume layer and the RAID layer, thereby separating the address attribution partitioning of the logical volume layer and that of the RAID layer. After the logical volume sends the data to the data cache, the RAID re-determines the controller, and flushes the data in the data cache to the RAID layer according to its own address space. That is, the address attribution partitioning of the RAID does not relay on that of the logical volume, that is, when the address attribution partitioning of the RAID changes, the RAID layer does not need to change the address attribution partitioning accordingly, thereby improving the flexibility of the RAID layer, alleviating the performance degradation caused by the attribution change, isolating the balance conduction of data across the logical volumes, and improving the system performance.

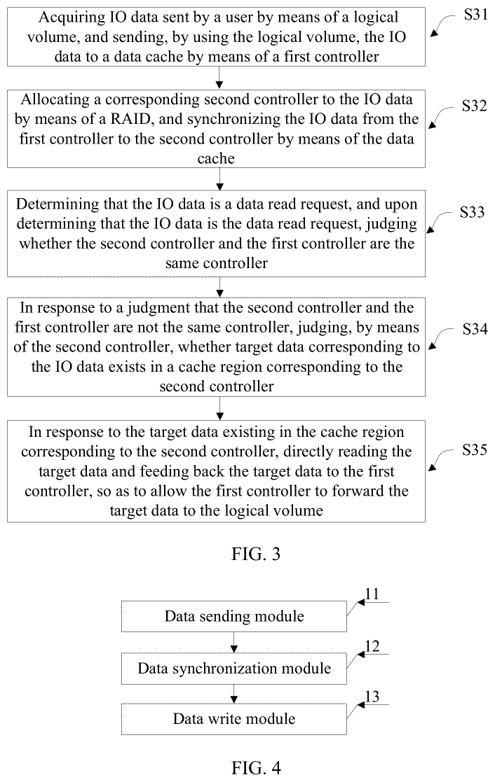

Correspondingly, some embodiments of the present application further disclose an IO processing apparatus. Referring to FIG. 4, the apparatus includes:
a data sending module 11, configured to acquire IO data sent by a user by means of a logical volume, and send, by using the logical volume, the IO data to a data cache by means of a first controller;
a data synchronization module 12, configured to allocate a corresponding second controller to the IO data by means of a RAID, and synchronize the IO data from the first controller to the second controller by means of the data cache; and
a data write module 13, configured to determine a corresponding target address space according to a pre-partitioned RAID layer address space by means of the second controller in response to a determination that the IO data is a data write request, and perform a data write operation on the target address space based on the IO data, where the pre-partitioned RAID layer address space is a RAID layer address space generated after partitioning a the corresponding address space for each controller at a RAID layer.

It may be seen from the above description that in the present embodiment the IO data sent by the user is acquired by means of the logical volume, and the IO data is sent, by using the logical volume, to the data cache by means of the first controller; the corresponding second controller is allocated to the IO data by means of the RAID, and the IO data is synchronized from the first controller to the second controller by means of the data cache; and in response to a determination that the IO data is the data write request, the corresponding target address space is determined according to a pre-partitioned RAID layer address space by means of the second controller, and the data write operation is performed on the target address space based on the IO data, where the pre-partitioned RAID layer address space is a RAID layer address space generated after partitioning a corresponding address space for each controller at the RAID layer. It may be seen that by independently partitioning the address space at the RAID layer and utilizing the data cache to isolate the address space partitioning between the logical volume layer and the RAID layer, thereby separating the address attribution partitioning of the logical volume layer and that of the RAID layer, and after the logical volume sends the data to the data cache, the RAID re-determines the controller, and flushes the data in the data cache to the RAID layer according to its own address space. That is, the address attribution partitioning of the RAID does not relay on that of the logical volume, that is, when the address attribution partitioning of the RAID changes, the RAID layer does not need to change the address space partitioning accordingly, thereby improving the flexibility of the RAID layer, alleviating the performance degradation caused by the attribution change, isolating the balance conduction of data across the logical volumes, and improving the system performance.

In some embodiments, the IO processing apparatus may include:
an address space partitioning unit, configured to perform address space partitioning at the RAID layer in a unit of stripe according to an address partitioning rule, and assign a unique controller for each group of address spaces.

In some embodiments, the IO processing apparatus may include:
a logical volume layer space partitioning unit, configured to partition, by means of the logical volume, a target unit-length space as a data block from an address space corresponding to a controller according to the RAID layer address space, so as to obtain a plurality of data blocks corresponding to a plurality of controllers, where the plurality of data blocks are configured to receive the IO data written by a user into the logical volume.

In some embodiments, the data synchronization module 12 may include:
a target storage address space determination unit, configured to select, by means of the RAID, a target storage address space from address spaces according to a current load condition of each address space; and
a second controller determination unit, configured to take the controller corresponding to the target storage address space as the second controller by querying the address space of the RAID layer.

In some embodiments, the IO processing apparatus may include:
a controller judging unit, configured to judge whether the second controller and the first controller are the same controller in response to a determination that the IO data is a data write request; and
a controller re-selection unit, configured to re-select a controller except the first controller as the second controller in response to a judgment that the second controller and the first controller are the same controller.

In some embodiments, the controller re-selection unit may include:
a cyclic selection unit, configured to select a next controller of the first controller as the second controller according to preset controller cyclic data.

In some embodiments, the controller re-selection unit may include:
a random selection unit, configured to randomly select a controller from controllers except for the first controller as the second controller.

In some embodiments, the IO processing apparatus may include:
a result feedback unit, configured to generate a data write completion result, and send a data backup completion result to the logical volume.

In some embodiments, the data synchronization module 12 may include:
a cache synchronization unit, configured to back up the IO data stored in a cache region corresponding to the first controller to a cache region corresponding to the second controller.

In some embodiments, the IO processing apparatus may include:
a synchronization node pair information storage unit, configured to generate synchronization node pair information corresponding to the IO data based on controller information of the first controller and the second controller, and store the synchronization node pair information.

In some embodiments, the IO processing apparatus may include:
a synchronization node pair information updating unit, configured to notify a corresponding controller to discard the old cached data according to the synchronization node pair information when a cache is updated, and establish new synchronization node pair information.

In some embodiments, the data write module 13 may include:
a read judging unit, configured to judge whether any controller is reading data in the target address space; and
a flushing unit, configured to perform data flushing to the target address space based on the IO data in response to no controller reading the data in the target address space.

In some embodiments, the data write module 13 may include:
a state detection unit, configured to detect an accessed state of the target address space in response to a e controller reading the data in the target address space; and
a flushing unit, configured to perform data flushing to the target address space based on the IO data in response to no controller reading the data in the target address space.

In some embodiments, the IO processing apparatus may include:
a controller judging unit, configured to judge whether the second controller and the first controller are the same controller in response to a determination that the IO data is a data read request; and
a data matching query unit, configured to judge, by means of the first controller, whether target data corresponding to the IO data exists in a cache region corresponding to the first controller in response to a judgment that the second controller and the first controller are the same controller;
a first data read unit, configured to directly read the target data in response to a determination that the target data exists in a cache region corresponding to the first controller, and feed back the target data to the logical volume.

In some embodiments, the IO processing apparatus may include:
a second data read unit, configured to read the target data corresponding to the IO data from the RAID by means of the first controller in response to no target data existing in the cache region corresponding to the first controller, and feed back the target data to the logical volume.

In some embodiments, the IO processing apparatus may include:
a data matching query unit, configured to judge, by means of the second controller, whether target data corresponding to the IO data exists in the cache region corresponding to the second controller in response to a determination that the second controller and the first controller are not the same controller; and
a third data read unit, configured to directly read the target data in response to a determination that the target data exists in the cache region corresponding to the second controller in response to a determination that the target data exists in the cache region corresponding to the second controller, and feed back the target data to the first controller, so as to allow the first controller to forward the target data to the logical volume.

In some embodiments, the IO processing apparatus may include:
a fourth data read unit, configured to send data read failure information to the first controller in response to a determination that no target data exists in the cache region corresponding to the second controller, so as to allow the first controller to read the target data corresponding to the IO data from the RAID after receiving the data read failure information, and feed back the target data to the logical volume.

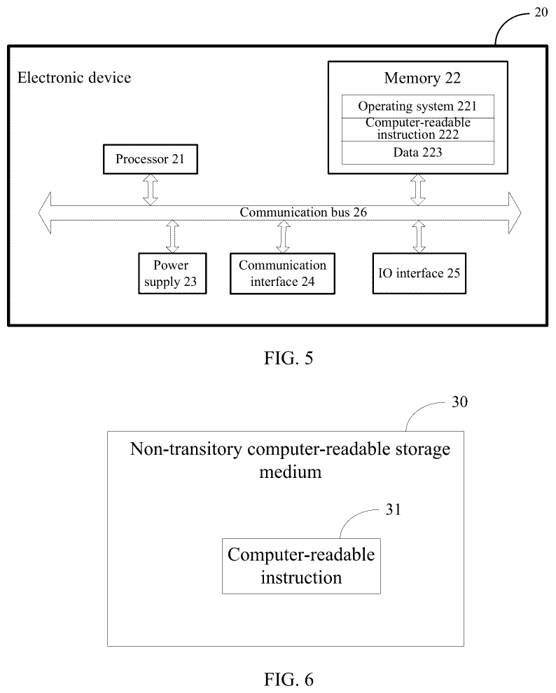

Further, some embodiments of the present application also disclose an electronic device. Referring to FIG. 5, the content in the figure may not be considered as any limitation to the application scope of the present application.

FIG. 5 is a structural schematic diagram of an electronic device 20 provided by some embodiments of the present application. The electronic device 20 may include at least one processor 21, at least one memory 22, a power supply 23, a communication interface 24, an IO interface 25, and a communication bus 26. The memory 22 is at least configured to store a computer-readable instruction, and the computer-readable instruction is loaded and executed by the processor 21 to implement relevant steps in the IO processing method disclosed in any aforementioned embodiment.

In the present embodiment, the power supply 23 is configured to supply working voltage to various hardware equipment on the electronic device 20. The communication interface 24 may establish a data transmission channel between the electronic device 20 and a peripheral device, and follows a communication protocol that may be suitable for the technical solutions of the present application, which is not limited herein. The I/O interface 25 is configured to acquire external input data or output data to outside, and an interface type may be selected according to an application requirement, which is not limited herein.

In addition, the memory 22 is used as a carrier for resource storage, and may be a read-only memory, a random-access memory, a disk, or a compact disk. Resources stored on the memory may include an operating system 221, a computer-readable instruction 222, data 223 including the IO data, and the like. The storage manner may be temporary storage or permanent storage.

The operating system 221 is configured to manage and control hardware equipment and the computer-readable instruction 222 on the electronic device 20, to enable the processor 21 to operate and process vast data 223 in the memory 22. The operating system may be Windows server, Netware, Unix, Linux, and the like. Besides the computer-readable instruction configured to implement the IO processing method performed by the electronic device 20 disclosed in any foregoing embodiment, the computer-readable instruction 222 may further include another computer-readable instruction configured to complete other specified work.

Further, some embodiments of the present application also disclose a non-transitory computer-readable storage medium. As shown in FIG. 6, the non-transitory computer-readable storage medium 30 stores a computer-readable instruction 31, and the computer-readable instruction 31, when loaded and executed by one or more processors, implements the steps of the IO processing method disclosed by any aforementioned embodiment.

Various embodiments of the present specification are described in a progressive manner, each embodiment focuses on the difference from other embodiments, and the same or similar parts between the embodiments may refer to each other. Apparatuses disclosed in embodiments are simple in description because they correspond to the methods disclosed in the embodiments, and relevant information was referred to the description of the method.

The steps of the methods or algorithms described in the embodiments disclosed herein may be implemented directly by hardware, software modules executed by a processor, or by a combination of the two. The software modules may be arranged in random access memory (RAM), internal memory, read-only memory (ROM), electrically programmable ROM (EPROM), electrically erasable programmable ROM (EEPROM), registers, hard disks, removable disks, compact disc read-only memory (CD-ROM), or any other form of storage medium known in the technical field.

Finally, it also should be noted that relational terms used herein such as first and second etc. are only used to distinguish one entity or operation from another entity or operation, and do not necessarily require or imply any such actual relation or sequence between these entities or operations. Moreover, terms “include”, “contain” or any other variations thereof are intended to cover a non-exclusive inclusion, whereby a process, method, article, or apparatus including a series of elements does not include only those elements but also other elements not expressly listed or also includes the intrinsic elements of the process, method, article, or apparatus. Without further limitations, an element defined by the sentence “including an” do not exclude the presence of other same elements in the process, method, article or apparatus including the element.

The IO processing system and method, the device, and the medium provided by the present application are described in detail above. The principle and embodiments of the present application are described herein with examples. The above embodiments are explained to help the understanding of the method and core concept of the present application. Meanwhile, for the ordinary skilled in the art, according to the concept of the present application, the embodiments and application ranges may be changed. In conclusion, the contents of this specification should not be construed as limiting the present application.

1. An input or output (IO) processing method, comprising:
acquiring IO data sent by a user by means of a logical volume, and sending, by using the logical volume, the IO data to a data cache by means of a first controller;
allocating a second controller to the IO data by means of a redundant array of independent disks (RAID), and synchronizing the IO data from the first controller to the second controller by means of the data cache; and
determining a target address space according to a pre-partitioned RAID layer address space by means of the second controller in response to a determination that the IO data is a data write request, and performing a data write operation on the target address space based on the IO data, wherein the pre-partitioned RAID layer address space is a RAID layer address space generated after partitioning a corresponding address space for each controller at a RAID layer.

2. The IO processing method according to claim 1, wherein the partitioning a corresponding address space for each controller at a RAID layer comprises:
performing address space partitioning at the RAID layer in a unit of stripe according to an address partitioning rule, and assigning a unique controller to each group of address spaces.

3. The IO processing method according to claim 1, further comprising:
partitioning, by means of the logical volume, a target unit-length space as a data block from an address space corresponding to a controller according to the RAID layer address space, so as to obtain a plurality of data blocks corresponding to a plurality of controllers, wherein the plurality of data blocks are configured to receive the IO data written by a user into the logical volume.

4. The IO processing method according to claim 1, wherein the allocating a second controller to the IO data by means of a RAID comprises:
selecting, by the RAID, a target storage address space from address spaces according to a current load condition of each address space; and
taking a controller corresponding to the target storage address space as the second controller by querying the RAID layer address space.

5. The IO processing method according to claim 1, wherein after the allocating a second controller to the IO data by means of a RAID, the method further comprises:
judging whether the second controller and the first controller are a same controller in response to a determination that the IO data is a data write request; and
in response to a judgment that the second controller and the first controller are the same controller, re-selecting a controller except the first controller as the second controller.

6. The IO processing method according to claim 5, wherein the re-selecting a controller except the first controller as the second controller comprises:
selecting a next controller of the first controller as the second controller according to preset controller cyclic data.

7. The IO processing method according to claim 5, wherein the re-selecting a controller except the first controller as the second controller comprises:
randomly selecting a controller, other than the first controller, from controllers as the second controller.

8. The IO processing method according to claim 5, wherein after the synchronizing the IO data from the first controller to the second controller by means of the data cache, the method further comprises:
generating a data write completion result, and sending a data backup completion result to the logical volume.

9. The IO processing method according to claim 1, wherein the synchronizing the IO data from the first controller to the second controller comprises:
backing up the IO data stored in a cache region corresponding to the first controller to a cache region corresponding to the second controller.

10. The IO processing method according to claim 1, wherein after the synchronizing the IO data from the first controller to the second controller by means of the data cache, the method further comprises:
generating synchronization node pair information corresponding to the IO data based on controller information of the first controller and the second controller, and storing the synchronization node pair information.

11. The IO processing method according to claim 10, wherein after the storing the synchronization node pair information, the method further comprises:
notifying a corresponding controller to discard old cached data based on the synchronization node pair information when a cache is updated, and establishing new synchronization node pair information.

12. The IO processing method according to claim 1, wherein the performing a data write operation on the target address space based on the IO data comprises:
judging whether any controller is reading data in the target address space; and
in response to no controller reading data in the target address space, performing data flushing to the target address space based on the IO data.

13. The IO processing method according to claim 12, wherein after the judging whether any controller is reading data in the target address space, the method further comprises:
in response to a controller reading data in the target address space, detecting an accessed state of the target address space; and
performing data flushing to the target address space based on the IO data in response to no controller reading data in the target address space.

14. The IO processing method according to claim 1, wherein after the synchronizing the IO data from the first controller to the second controller by means of the data cache, the method further comprises:
judging whether the second controller and the first controller are a same controller in response to a determination that the IO data is a data read request;
in response to a judgment that the second controller and the first controller are the same controller, judging, by means of the first controller, whether target data corresponding to the IO data exists in a cache region corresponding to the first controller; and
in response to the target data existing in the cache region corresponding to the first controller, directly reading the target data and feeding back the target data to the logical volume.

15. The IO processing method according to claim 14, wherein after the judging whether target data corresponding to the IO data exists in a cache region corresponding to the first controller, the method further comprises:
in response to no target data existing in the cache region corresponding to the first controller, reading, by means of the first controller, the target data corresponding to the IO data from the RAID, and feeding back the target data to the logical volume.

16. The IO processing method according to claim 14, wherein after the judging whether the second controller and the first controller are a same controller, the method further comprises:
in response to a judgment that the second controller and the first controller are not the same controller, judging, by means of the second controller, whether target data corresponding to the IO data exists in a cache region corresponding to the second controller; and
in response to the target data existing in the cache region corresponding to the second controller, directly reading the target data, and feeding back the target data to the first controller, so as to allow the first controller to forward the target data to the logical volume.

17. The IO processing method according to claim 16, wherein after judging whether target data corresponding to the IO data exists in a cache region corresponding to the second controller, the method further comprises:
in response to no target data existing in the cache region corresponding to the second controller, sending data read failure information to the first controller, to allow the first controller to read the target data corresponding to the IO data from the RAID after receiving the data read failure information and feed back the target data to the logical volume.

18. The IO processing method according to claim 14, wherein after the judging whether the second controller and the first controller are a same controller, the method further comprises:
in response to a judgment that the second controller and the first controller are the same controller, judging whether the target data corresponding to the IO data exists in the cache region corresponding to the first controller by means of the first controller; and
in response to a judgment that the target data exists in the cache region corresponding to the first controller, reading the target data directly, and feed the target data back to the logical volume.

19. An electronic device, comprising a memory and one or more processors, wherein the memory has a computer-readable instruction stored therein, and the computer-readable instruction, when executed by the one or more processors, causes the one or more processors to:
acquire input or output (IO) data sent by a user by means of a logical volume, and send, by using the logical volume, the IO data to a data cache by means of a first controller;
allocate a second controller to the IO data by means of a redundant array of independent disks (RAID), and synchronize the IO data from the first controller to the second controller by means of the data cache; and
determine a target address space according to a pre-partitioned RAID layer address space by means of the second controller in response to a determination that the IO data is a data write request, and perform a data write operation on the target address space based on the IO data, wherein the pre-partitioned RAID layer address space is a RAID layer address space generated after partitioning a corresponding address space for each controller at a RAID layer.

20. A non-transitory computer-readable storage medium storing a computer-readable instruction, wherein the computer-readable instruction, when executed by one or more processors, causes the one or more processors to:
acquire input or output (IO) data sent by a user by means of a logical volume, and send, by using the logical volume, the IO data to a data cache by means of a first controller;
allocate a second controller to the IO data by means of a redundant array of independent disks (RAID), and synchronize the IO data from the first controller to the second controller by means of the data cache; and
determine a target address space according to a pre-partitioned RAID layer address space by means of the second controller in response to a determination that the IO data is a data write request, and perform a data write operation on the target address space based on the IO data, wherein the pre-partitioned RAID layer address space is a RAID layer address space generated after partitioning a corresponding address space for each controller at a RAID layer.
